(19) United States
(12) Patent Application Publication
(10) Pub. No.: US 2021/0086663 A1
(43) Pub. Date: Mar. 25, 2021

(54) Breath Saver Car Seat Alarm System

(71) Applicant: Mayquie Jackson, Shreveport, LA (US)

(72) Inventor: Mayquie Jackson, Shreveport, LA (US)

(21) Appl. No.: 16/578,306

(22) Filed: Sep. 21, 2019

(51) Int. Cl. B60N 2/26; B60N 2/00

(52) U.S. Cl. CPC B60N 2/26; G08B 21/0269; B60N 2/002

(57) ABSTRACT

The present invention generally relates to improvement in automobile car seat a new generation car seat alarm system for an infant/toddlers car seat. There is a known automobile car seat in which a Breath Saver Car Seat Alarm System made of motionless sensors inside of a pad that's placed between the car seat and the infant/toddler, with On-board diagnostics II (OBD2) that includes an Global Positioning System (GPS) which is plugged into the car OBD-II port as a sensor and communication with messaging formats and signaling protocols, professional Bluetooth and Wireless to communicate with the automobile car seat sensor pad, car windows, car horn through a Breath Saver Car Seat Alarm System App for iPhone, Android, and another Computer devices to the parent, caregiver and police to locate and rescue the infant/toddler for the danger of Heatstroke or Hypothermia.

### TECHNICAL FIELD

The present invention generally relates to the technological innovative improvements within a automobile car and carseat. Designed to protect and save the delicate lives of infants and toddlers from extreme weather due to excessive heat or cold leading to either heat stroke or hypothermia.

### BACKGROUND ART

Breath Saver Car Seat Alarm System is designed with motionless sensors located inside of a pad that's placed between the car seat and the infant/toddler, with On-board diagnostics II (OBD2) that includes an Global Positioning System (GPS) which is plugged into the car OBD-II port as a sensor. This device is equipped with communicative abilities to send forth messages signaling protocols and professional within a critical time frame. Bluetooth and Wireless to communicate with the automobile car seat sensor pad, car windows, car horn through a Breath Saver Car Seat Alarm System App for iPhone, Android, and another Computer devices to the parent, caregiver and police to locate and rescue the infant/toddler for the danger of heatstroke.

### SUMMARY OF THE INVENTION

An object of the present invention is to save the breath of infants/toddlers from being left and to risk of Heatstroke or Hypothermia. To provide a car seat alarm that would sensor an infant/toddler left in a hot or cold car and to give instance relief and the change of rescue.

In accordance with the present invention, there is to provide an infant/toddlers automobile car seat with an alarm comprising with motionless sensor pad fixedly between the infant/toddler and official car seat made of waterproof material and multiple motionless sensor, ODB-II capabilities messaging formats and signaling protocols to communicate to roll down the window, to alert by activating the car horn, instantly calling, email and text messages parents/caregivers cell phones of parents or caregiver. Lastly activating Global Positioning System (GSP) to alerting the police to locate and rescue all through the Breath Saver Car Seat Alarm System App.

According to the present invention, as the motionless sensor pad will alert the OBD-II and the Breath Saver Car Seat Alarm System App that the infant/toddler in still sitting in the car seat and the sensor will calculate the temperature of the car and temperature of the infant/toddler and the heart rate car seat after the car seat alarm will begin its timer clock at four (4) minutes and fifty-nine (59) seconds. Next the OBD-II that's plugged into the car will begin to messaging formats and signaling protocols to roll down the window, to alerts by activating the car horn, instantly calling, emailing and text messages cell phones of parents or caregiver lastly activating Global Positioning System (GPS) to alerting the police to locate and rescue.

Furthering, according to the present invention having the capabilities in calling, emailing and texting messages to the cell phones of parents or caregiver. Lastly the Breath Saver Car Seat Alarm System will rolled down the windows activate and the Global Positioning System (GSP) to alerting the police with its messaging formats and signaling protocols professional with Bluetooth or Wireless capabilities to communicate where the car is located through the Breath Saver Car Seat Alarm System App for iPhone, Android, and Computer devices.

### BRIEF DESCRIPTION OF THE DRAWINGS

FIG. 1 is a front view illustrating one preferred embodiment of Breath Saver Car Seat Alarm System motionless sensor pad according to the present invention;

FIG. 2 is a partially exploded perspective back view of the Breath Saver Car Seat Alarm System motionless sensor pad.

FIG. 3 is a front view perspective of the Breath Saver Car Seat Alarm System OBD-II device

FIG. 4 are partially cross-sectional views of the same showing how the Breath Saver Car Seat Alarm System OBD-II device

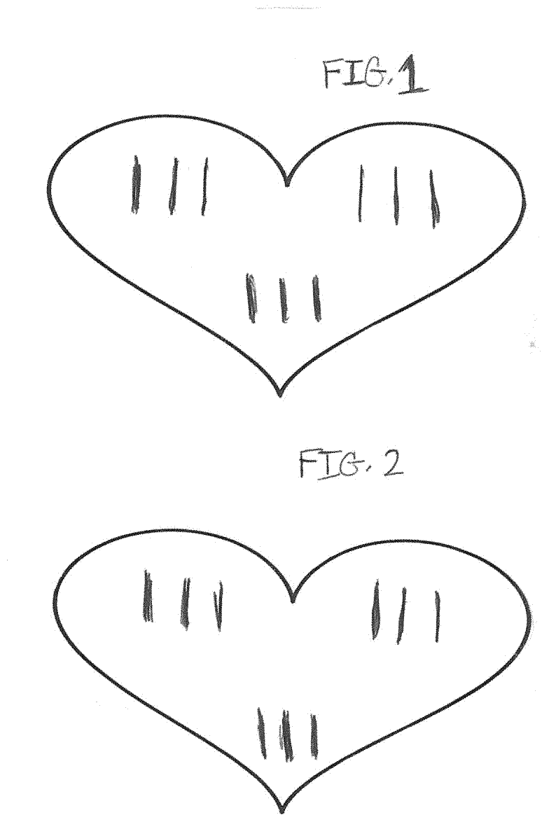

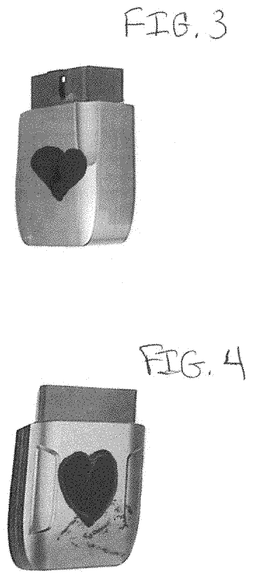

### DETAILED DESCRIPTION OF PREFERRED EMBODIMENTS

A Breath Saver Car Seat Alarm System is to provide a motionless sensor pad fitted between automobile car seat and under the shoulder and bottom of the infant/toddler, On-board diagnostics II (OBD-II) with Global Positioning System (GPS) capabilities messaging formats and signaling protocols plugged in the automobile OBD-II port.

The motionless sensor pad is a simple heart shape material with multiply motionless sensor inside of the pad place between the automobile car seat and infant/toddler. The upper part of the heart shape is placed underneath the infant/toddler shoulders and the bottom part of the heart shape is place underneath the infant/toddler bottom.

The multiply motionless sensor inside of the pad would communicate with Breath Saver Car Seat Alarm System OBD-II port plugged into the automobile OBD-II port.

1. A car seat for an automobile with an lifesaving alarm comprising
A motionless sensor pad fixedly between the infant/toddler and car including the instantly calculating the temperature of the car, infant/toddler, the heart rate of the infant/toddler thereof;
an On-board diagnostics II (OBD-II) and Global Positioning Systems (GPS) capabilities messaging formats and signaling protocols to roll down the window, to activate alerts by activating the car horn, instantly calling, emailing and texting messages cell phones of parents or caregivers. To activate the Global Positioning System (GSP) to alerting the police to locate and rescue;
A Breath Saver Car Seat Alarm System App for monitoring and to receiving all messaging formats and signaling protocols;
Characterized in that said motionless sensor pad having two parts; the heart shape pad and multiply motionless sensors fitted inside of the pad.

2. The automobile Breath Saver Car Seat Alarm System as claimed in claim characterized in that a motionless sensor waterproof movably pad that's between the car seat and the infant/toddler for the detection of the infant/toddler is left in the car seat increasing the chance of the infant/toddler of being saved before an Heatstroke or Hypothermia begin.

3. The car seat as claimed in claim characterized in that said On-board diagnostics II (OBD-II) plugged into On-board diagnostics II (2) port inside the automobile having the engaging all the capabilities of messaging formats and signaling protocols to roll down the window, activate alerts by activating the car horn, instantly sending and communicating calling, emailing and texting messages cell phones that the a infant/toddler is left in the car seat to the parents or caregiver.

4. Breath Saver Car Seat Alarm System has a countdown timer for the total four (4) minutes and fifty-nine (59) seconds multiply motionless sensors as claimed of the proceeding claims characterized in the alarming that an infant/toddler has not been removed for the car seat comprises a sensor in the Breath Saver Car Seat Alarm System pad thereof to securely fixed between the car seat and the infant/toddler.
